(19) United States
(12) Patent Application Publication
(10) Pub. No.: US 2005/0184422 A1
(43) Pub. Date: Aug. 25, 2005

(54) Molded display forms

(76) Inventors: James Talaric, Louisville, CO (US); James D. Barber, Longmont, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/109,513

(22) Filed: Apr. 19, 2005

Related U.S. Application Data
(62) Division of application No. 09/846,766, filed on Apr. 30, 2001.

(51) Int. Cl. B29C 41/04

(52) U.S. Cl. 264/71; 264/73; 264/310

(57) ABSTRACT

Methods of making a molded display form (i.e. a mannequin) or other article are provided, of an elastomeric material having a pigment and/or dye mixed therein, said form having a selected uniform color throughout the thickness of said material. Any desirable color may be selected, e.g., skin color (to approximate that of any race) grey, tan, red, blue, yellow, metallic colors such as gold and silver, and mixtures thereof. White and black molded articles are also provided herein. The processes of this invention are especially suitable for producing articles having a uniform color throughout without streaking. The forms of this invention are non-brittle, resist burning, and stand up well to high temperatures. If they are scraped or chipped, the uniform color of the material throughout will make the injury less noticeable. The material is also soft enough that seam lines may eliminated by buffing with synthetic pads, and because of the uniform color of the material, there is no need to paint over the buffed surface.

### CROSS-REFERENCE TO RELATED APPLICATIONS

This application is a divisional of U.S. patent application Ser. No. 09/846,766 filed Apr. 30, 2001, incorporated herein by reference to the extent not inconsistent herewith.

### BACKGROUND

Forms (also known as mannequins) for display of clothing have traditionally been molded from plaster, or fashioned from sheets of rubberized acrylic material (U.S. Pat. No. 5,310,099), other plastic (U.S. Pat. No. 4,798,317), or cardboard or other sheet-like material (U.S. Pat. No. 5,409,150). Molded mannequins, such as those made by rotational molding, typically require expensive stainless steel or aluminum molds and have to be backed with foam to achieve sufficient rigidity.

Since such forms are subject to rough handling by personnel and customers, molded forms are subject to chipping (U.S. Pat. No. 5,310,099). Most molded forms are painted after being molded, and when chipped, the underlying color of the plaster or plastic from which they are molded is clearly visible, destroying the value of the form.

Molded forms typically have a visible seam line or other unwanted protuberances (flash) immediately after the mold is opened which must be removed. The surface of the form, where the unwanted material has been removed, is usually different from the surface of the remainder of the form, e.g. shiny rather than matte, and the entire surface of the form must then be treated using expensive processes such as sandblasting and/or surface coating, to produce an aesthetically pleasing uniform appearance.

Forms are needed which can withstand rough handling, which do not require sandblasting or surface coating, which can be molded using inexpensive molds to make non-brittle products colored as desired so that they do not easily chip, or if they do, the color is not different inside so the injury to the form is less detectable.

Methods of molding using elastomeric materials are known to the art. Such methods include those disclosed in U.S. Pat. No. 5,064,870, disclosing a method for producing highly elastic cold-curing polyurethane foams, U.S. Pat. No. 4,383,079 dealing with extension of polyurethane cure time, U.S. Pat. No. 3,933,692, and U.S. Pat. No. 4,638,016, dealing with catalysts useful in such processes, and U.S. Pat. Nos. 4,297,472, 5,208,368, 4,721,531, 5,994,579, 5,476,892, 5,156,762, 4,021,385, 4,743,626, and 5,998,532, which deal with coloring or stabilizing the color of polyurethane materials.

Attempts have previously been made to provide display forms made of black material throughout the thickness of the material, using gritty carbon particles to achieve the color. However, these methods were unsatisfactory because pump components used in production molding were quickly eroded by the hard pigment.

All publications referred to herein are hereby incorporated by reference in their entirety to the extent not inconsistent herewith.

### SUMMARY OF THE INVENTION

A molded display form or other article is provided, made of an elastomeric material having a pigment and/or dye mixed therein, said form having a selected uniform color throughout the thickness of said material. Any desirable color may be selected, e.g., skin color (to approximate that of any race) grey, tan, red, blue, yellow, metallic colors such as gold and silver, and mixtures thereof. White and black molded articles are also provided herein. The processes of this invention are especially suitable for producing articles having a uniform color throughout the thickness of the material without streaking.

The materials and processes of this invention are also useful for molding other retail display forms such as frames (e.g. for mirrors and pictures), urns, fixtures, furniture, display props, and garden furniture.

The polymer mix and molded articles of this invention should have properties allowing efficiency in processing and durability to withstand the type of shipping and handling to which display forms are subject. Specifically, the polymer mix should have a low enough viscosity to flow into the mold easily, and coat the interior mold surfaces, should have a short demold time, a gel profile which is flat for the first two quarters, starts to go up slowly during the third quarter, and rises steeply during the last quarter; a gelling period between about 2 and about 2.5 minutes, and substantially no gritty pigment or other material in the mix which would damage pumps. The molded articles should be non-brittle, resist deformation under load at temperatures up to at least about 140° F., preferably about 160° F., be resistant to denting, be low in flammability, resist deformation during heat cycling or long periods of high temperatures, be abrasion resistant but soft enough to be hand buffed to remove flash, and should resist discoloration over periods of about one to about five years as a result of ultraviolet light or temperature exposure. Important properties for the molded articles of this invention are brittleness as measured by ASTM D256-97 impact test, linear burn rate as measured by ASTM D 635-98, and heat deformation as measured by ASTM D 648-98.

Preferably the articles of this invention are made by a process of cold rotational molding (rather than a melted thermoplastic rotational molding process), at a temperature not exceeding about 200° F.

Preferably, the elastomeric material used to form the form is thermosetting polyurethane. Other thermosetting polymers may also be used.

In a two-component system such as a urethane system, the physical properties of the material may be adjusted, as is known to the art, by changing the type and/or amount of polyol or polyester and isocyanate components in accordance with principles known to the art, and by the use of various additives.

Methods of making the forms or other molded display forms of this invention using elastomeric materials comprise the steps of:
a. providing a pigment and/or dye effective to produce a desired color in said form;
b. providing polyol or polyester resin components;
c. providing isocyanate components;
d. providing one or more curing catalysts;
e. optionally providing an ultraviolet (UV) stabilizer;
f. optionally providing a viscosity controlling additive;
g. optionally providing a defoaming agent;
h. optionally providing drying agents and fillers;
i. mixing said components to form a mixture;
j. putting said mixture into a mold;
k. rocking or rotating the mold in multiple directions;
l. allowing said mixture to gel (as determined by rate of viscosity increase, see FIGS. 10 and 11) within a gelling period of between about 2.0 to about 3.5 minutes, preferably about 2.25 minutes at a temperature of between about 70° F. and about 77° F.;
m. allowing a demold time of within about 9 to about 15 minutes, preferably about 9 minutes to about 12 minutes, to form a molded article; and
n. removing the molded article from the mold.

The methods of this invention may also include removing unwanted protuberances and seams (flash) from the demolded article.

### BRIEF DESCRIPTION OF THE DRAWINGS

FIG. 1 shows a hollow display form of this invention lined for the color pink, broken away to show the uniform color throughout the thickness of the material.

FIG. 2 shows a display form molded to produce a seam or flash.

FIG. 3 is an expanded view of a cross-section of the shell of the form showing the flash of FIG. 2.

FIG. 4 is an expanded view of a cross-section of the shell of the form showing the flash of FIG. 2 after trimming.

FIG. 5 is an expanded view of a cross-section of the shell of the form showing the flash of FIG. 2 after trimming and prepping.

FIG. 6 shows a display form of this invention molded to produce a seam or flash which has been partially removed by buffing.

FIG. 7 is an expanded view of a cross-section of the shell of the form showing the flash of FIG. 6.

FIG. 8 is an expanded view of a cross-section of the shell of the form showing the flash of FIG. 6 after buffing.

FIG. 9 is a flow chart of the cold rotational molding process.

FIG. 10 graphs viscosity profiles of uncolored material having suitable properties during molding.

FIG. 11 graphs viscosity profiles of colored material of this invention having suitable properties during molding.

### DETAILED DESCRIPTION

Molded display articles are provided which have a uniform selected color throughout the thickness of the material. The term “uniform” with respect to the selected color(s) of the form material means that the color does not appear different to the eye inside the material, if the material is chipped, cut or broken, than on the molded surface. Preferably, the color also does not appear different to the eye on different portions of the surface.

The display forms and other molded articles of this invention are preferably made using a cold rotational molding process at a temperature no more than about 200° F. Preferably the process is conducted at a blended material temperature no more than about 105° F., and a mold temperature no more than about 150° F., and preferably a blended material temperature between about 90° F. and about 100° F., and a mold temperature between about 120° F., and about 135° F., and most preferably a blended material temperature of about 90° F. and a mold temperature of about 135° F., so that the material cures properly and is firm at demold.

At higher temperatures, the material gel time would be extremely short which would affect the curing process, and could make the part more brittle and of nonuniform thickness. At lower temperatures, the material would not cure properly and would be soft and/or gooey at demold, or would take a long time to cure to demold properties.

The molded articles are preferably hollow, i.e. have a void volume inside, with walls having a thickness between about 0.0625 inches and about 0.225 inches, preferably between about 0.0925 inches and about 0.125 inches. Preferably no backing or stuffing material such as foam is required to maintain the shape and desired rigidity of the molded articles.

Preferably the forms or other molded articles of this invention have a matte finish. The forms as molded have a uniform color throughout the thickness of the material, but coatings and finishes may be applied to the surface if desired. The forms may also be molded with a glossy finish when desired.

A preferred material for this invention is polyurethane. Polyurethane molding is well known to the art. Polyurethanes are produced by a chemical reaction between polyols or polyesters and isocyanates. Generally, molding methods use two liquid components designated in the industry as component (A), the isocyanate component, and component (B), the resin component. The resin component (B) generally contains the backbone of polyether or polyester, chain extender, catalyst and flow control agent. Pigment and/or dyes and dispersions thereof also are generally included in or added to component (B) prior to the reaction with the isocyanate (component (A)). The coloring agent must be compatible with the resin component (B) so that the color will be uniformly dispersed in component (B). If the pigment or dye is not compatible with component (B), then settling of the pigment and clogging of filter can result. U.S. Pat. No. 4,721,531, incorporated herein by reference, discloses methods for incorporating pigment into such mixes along with ultraviolet light stabilizing compounds and heat stabilizers to provide uniform dispersion. As used herein, dyes are soluble in the mix, while pigments may or may not be soluble.

Urethanes can be prepared by a “one-shot” method in which diisocyanate, polyol or polyester, chain extender, catalyst and any additives are combined in a single step followed by casting of the elastomer. However, the preferred method of preparation of urethanes in this invention employs prepolymers (“A” side equivalents) generated by the reaction of the astoichiometric excess of isocyanate, e.g., MDI, with the chosen polyol or polyester. Reaction to form the urethane is accomplished by completion of addition of the desired amount of polyol or polyester and/or chain extender (typically called a curative in methods utilizing prepolymers) with catalyst and any other additives. Prepolymers vary in the diisocyanate used, and the amount and type of resin used.

Preferred isocyanate components of this invention are those based on methylene diphenyl diisocyanate (MDI). A useful isocyanate component for use herein is BASF Elastofoam I 36470T Isocyanate having a specific gravity of 1.210 g/cc and a viscosity of 650 cp at 77° F.

A preferred polyol component of this invention is BASF Elastocast No. 70903R, Elastocast No. 70905R, or Elastocast No. 70906R resin having a specific gravity of 1.062 g/cc and a viscosity of 1120 cp at 77° F.

The components are preferably mixed at a material temperature of 65-80° F., mold temperatures of 120-160° F., and using a demold time of 12-15 minutes. Gel time is about 195 seconds at 77° F.

The finished article typically has a Shore D hardness at 25° C. of 72 and a notched izod score at 25° C. of 2.7 ft.lb./inch.

The “B” side (polyol or polyester) components of the polyurethane formulations can also comprise chain extenders or curatives. These materials are short chain molecules, typically glycols in MDI-based formulations.

Molds for polyurethane materials are known to the art. The cold rotational molding process used in this invention allows epoxy molds to be used. The fiber-reinforced epoxy molds used in this invention are preferably made of high-temperature epoxy resins having an aluminum-filled face coating on the inner surface, 0.003 to 0.005 inches in thickness covered with a resin and fiberglass buildup to about ⅜ inch. Metal molds such as stainless steel or aluminum molds may also be used, but are more expensive and require more heat to process the material properly. Epoxy molds are poor conductors of heat and therefore do not require an external heating source to maintain the desired temperature. The exothermic urethane reaction within the mold can be sufficient to maintain the desired temperature.

Conventional mixing procedures for mixing the polyol or polyester and isocyanate components of a polyurethane system may be used, i.e. blade mixers may be used, but impingement mixing is preferred, wherein the components are mixed at high pressures and flowed together into the mold. Basically, the material components are mixed by impingement in a mixing chamber of extremely small dimensions, which, at the end of the pouring process, self cleans with a mechanically driven piston. This type of mixing and cleaning eliminates the need for chemical solvents and air for the cleaning of the mixing chamber. An L-shaped mixing head is preferred, consisting of two cylindrical chambers of two different sizes in which two clean-out pistons operate. The smaller chamber (mixing chamber), introduces the two components at high velocity, creating turbulence and impingement of the two components. The larger chamber, positioned at 90° to the smaller one, is the discharge duct for the material. The material passing from the first to the second chamber completes the component mixing. The material leaving the mix-head becomes low in velocity and splash free.

When using impingement mixing, antifoaming agents are desirable additives. Antifoaming agents known to the art may be used, such as BASF 70594 in an amount between about 0.02% and about 0.09%, preferably about 0.05% by weight, i.e., an amount sufficient to control bubble formation within the mix but not so great as to adversely affect the desirable physical properties of the material as discussed herein.

A catalyst or catalysts known to the art may be added to the mixture in suitable amounts, e.g. about 0.2% of the resin component, to affect the gelling profile and cure rate. Suitable catalysts are known to the art and include BASF Product No. 40850A. The type of catalyst should be one which improves the back-end cure for an accelerated cure rate in the last 25% of the total cure cycle. The type and amount of catalyst employed is adjusted to achieve a selected gelling period ranging from about 2 minutes to about 3.5 minutes after the composition enters the mold. Gelling periods of a given formulation can be assessed as described herein. Temperatures in the mixing chamber may be adjusted for use of different catalysts. Preferred catalysts of this invention are organometallic catalysts, e.g., based on tin, lead or mercury. A useful catalyst herein is BASF Product No. 40850A, or BASF catalyst NB 19189-4-117-3. Catalysts are typically diluted in a carrier that is compatible with the polyurethane chemistry. A preferred carrier of this invention is the system polyol or polyester.

Other additives such as drying agents, UV stabilizers, viscosity-controlling agents, surfactants, stabilizers, blowing agents, chain extenders, catalysts, and the like as known to the art, may also be added to bring the properties of the uncured mixture and cured product within the desirable parameters discussed herein. Reaction conditions may also be used to control the properties of the molded products, all as known to the art.

The inside surface of the mold can be textured when the mold is manufactured, or the inside surface can be treated, such as by sandblasting, bead blasting, etching, hand sanding or other means known to the art to provide a desirable surface texture to the molded article.

The mold may be treated with conventional release agents to facilitate demolding and prevent the cured material from sticking to the interior mold surfaces.

The molded articles should have desirable properties discussed below, achievable through routine optimization by those skilled in the art of polyurethane chemistry and/or by methods taught herein.

They should have a uniform color throughout the thickness of the material. This is achieved herein by providing a pigment dispersion and/or dye which has a viscosity such that it mixes readily with the polyol or polyester component of the material before mixing the isocyanate component. Pigments or dyes in liquid or paste form are preferred, as mineral pigments in powder form quickly erode pump components used in the production molding apparatus. During development of this invention, it was attempted to add pigments and/or dyes to the standard E-Flex™ material of Fusion Specialties, Inc., Broomfield, Colo. However, the resultant material was streaked, i.e. non-uniform in color throughout the thickness of the material, and had lost many of the desirable properties of the original E-Flex™ material.

One polyurethane formula of this invention utilizes BASF resin Product No. 70512R and BASF isocyanate Product No. WUC 3238T ISO. This material comprises an organic pigment or dye in paste form obtained from P.A.T. Products, Inc., Bangor, Me., manufactured by Repi S.p.A. An array of suitable colors are available including bright white REPITAN 18361 and skin REPIPLAST/CE 09470. These pigments are preferred for use in this invention. The pigments should have a mho hardness less than about 6.5 in order to be compatible with production equipment.

The viscosity of the material entering the mold is also important. The polymer mix should have a viscosity sufficiently low that it can wet all interior surfaces of the mold upon injection, e.g., the viscosity should be between about 500 and about 4000 cp, preferably between about 1100 and about 2000 cp, and more preferably between about 1100 and about 1800 cp as it enters the mold. This may be achieved using a polyol or polyester component (also referred to herein as a “resin component”) having a viscosity at 77° F. between about 1000 and 4000 cp, preferably between about 1700 to about 2100 cp. The isocyanate component should have a viscosity at 77° F. between about 400 and 1000 cp, preferably between about 600 and 700 cp. As is known to the art, viscosity may be controlled by viscosity controlling additives, and type and molecular weight of components.

The molded articles of this invention should have a short demold time (“demold time” refers to the amount of time the material is resident in the mold before the molded article is removed from the mold). The demold time should be between about nine and about twelve minutes. The material should be of uniform texture, i.e. not lumpy. It should have a gelling period of between about 2.0 and about 3.5 minutes. To achieve the short demold time and uniform texture, the gel profile should be flat for the first two quarters of the gelling period, should start to rise during the third quarter, and rise steeply during the last quarter. The material should be in a liquid state for long enough to coat the inner mold surfaces. Too rapid gelling would result in lumps and uneven surfaces. The gelling should be as gradual as possible for as long as possible to prevent lumps, then should finish rapidly. During the remaining time in the mold the material cures to sufficient hardness to be demolded, and continue curing for up to 72 hours outside of the mold.

An important property for the molded articles of this invention is lack of brittleness so that arms, legs, fingers and other body parts do not break during shipping and use. Preferably the materials have a high Izod Impact energy as measured by ASTM D 256-97 (Method A) at 75° F. exceeding about 2 ft. lb./inch, preferably between about 2 and about 3 ft. lb./inch, more preferably at least about 2.40 ft. lb./inch, and most preferably at least about 2.75 ft. lb./inch. A TUP impact exceeding 180 ft. lb. Using a twelve-pound weight as measured by ASTM D 2444 is also desirable.

The molded articles should not deform under load (especially under their own weight) at high temperatures, so as to be able to withstand such shipping conditions as being kept in a truck container in the summer. For example, the molded articles should not visibly sag, wrinkle, or have the parts fuse together, at temperatures up to about 120 to 160° F., preferably 140° F. or above, for at least about 72 hours.

They should also be resistant to denting under normal use, i.e. they should exhibit resilience when deformed flexurally by 5% of the material thickness at 110° F. as measured by ASTM D 790-99. They are more preferably resistant to denting at 100° F. and have a flexural stress value of at least about 800 psi at deflection 5% of their thickness. They should have a flexural modulus between about 50,000 and about 500,000 psi, preferably between about 50,000 and about 100,000 at room temperature (73° F.)as measured by ASTM D 790-99, and have a flexural modulus at 110° F. between about 20,000 and about 60,000 psi.

Preferably the molded articles are relatively inflammable, and should have a linear burn rate of no more than about 40 mm/minute, and preferably no more than about 20 to about 25 mm/minute as measured by ASTM D 635-98.

Heat cycling should not cause dimensional changes. There should be less than about 0.5% and preferably less than about 0.2% change in dimensions of molded parts when the material is maintained at 120° F. for 21 days, or cycled between 32° F. and 120° F. every twelve hours for 21 days.

The molded articles should be abrasion resistant, but are preferably soft enough to be readily abradable by hand using sandpaper to remove seams (also referred to herein as “flash”). If coarser sandpaper is used, unsightly scratches may occur. Using materials of this invention having uniform coloration throughout the thickness of the material makes the buffed seam substantially invisible. A synthetic buffing pad such as a 3M Scotchbrite® pad may then be used if necessary to restore matte finish where the flash has been sanded off. As is known in the art, seams can be reduced or eliminated by lowering the pressure within the mold and/or ensuring better fitment between the mold pieces. However, when unwanted flash material is present, it may be removed by means known to the art such as cutting, sanding, sandblasting and the like. Such methods leave a different texture where the unwanted material has been removed, so that the surface should then be treated to provide a uniform surface, e.g. by sanding or by use of a scraping tool. In a preferred embodiment of this invention, using material responsive to surface modification with sandpaper, preferably of 100 grit or finer, and which may be buffed by hand to a uniform matte finish, e.g. using a 3M Scotchbrite® pad, more expensive sanding and/or coating steps may be dispensed with. Abrasion resistance can be controlled by using a mix with a higher polyol or polyester to isocyanate mixture to achieve a softer molded article.

The molded articles for display should resist discoloration as a result of ultraviolet (UV) light or high temperatures in indoor service environments exposed to a spectrum of sunlight through window glass and the emissions of fluorescent and incandescent lighting lamps for up to at least about two years, preferably at least about five years. Ultraviolet-stable means minimal degradation of materials when exposed to sunlight (especially ultraviolet), and high temperatures. Preferably, any change in color should be less than one or two shades (a shade being a difference detectable by the human eye) over a one to three year period, and preferably over a five-year period. Such materials should have a total difference (DE) on the CIE L*a*b* scale of less than about 12 over a period of one year under normal show window conditions, e.g. exposed to sunlight through glass. The UV stability may be controlled by use of UV stabilizing compounds as known to the art.

The molded articles should have a Shore hardness exceeding about D10, preferably exceeding about D70, when tested by ASTM D 2240.

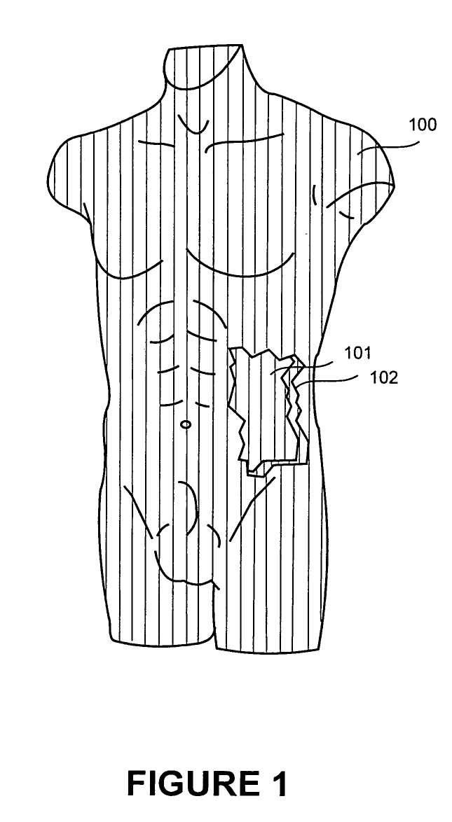

FIG. 1 shows a hollow display form 100 of this invention lined for the color pink. A hole 101 has been made in the form to show the uniform color throughout the thickness of the material 102.

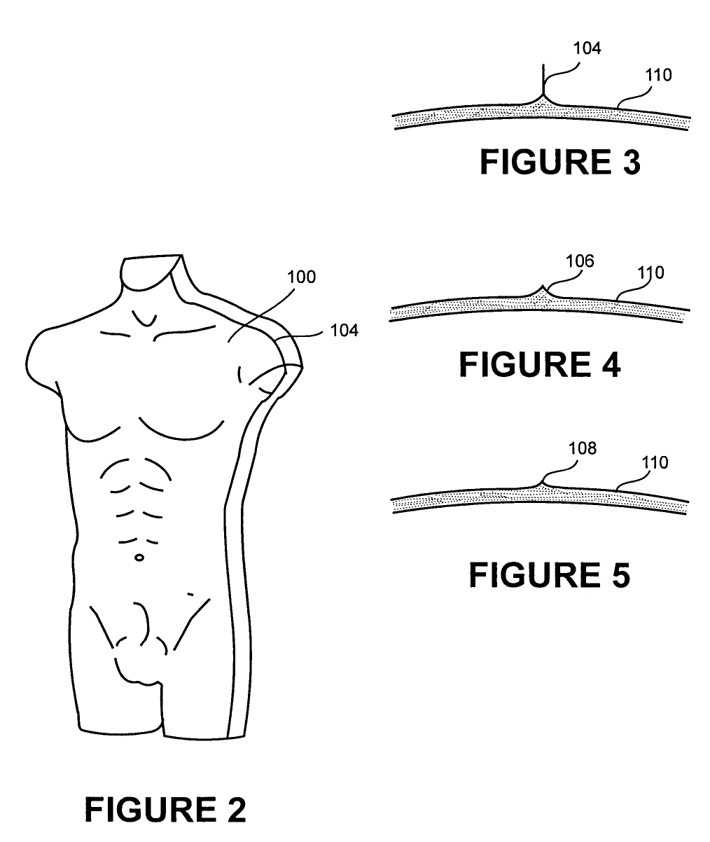

FIG. 2 shows a display form 100 made of a prior art material not having a uniform color throughout the thickness of the material, molded such that a seam (flash) 104 is produced. FIG. 3 is an expanded view of a cross-section of the form shell 110 showing the flash 104 of FIG. 2. FIG. 4 is an expanded view of a cross-section of the form shell 110 showing the trimmed flash 106. FIG. 5 is an expanded view of a cross-section of the form shell 110 showing the trimmed and prepped flash 108. The prepping step involves amending the texture and color of trimmed flash to match the surface of the rest of the form. This figure illustrates the labor-intensive steps which must be taken to remove flash when the mold material does not have a uniform color throughout the thickness of the material.

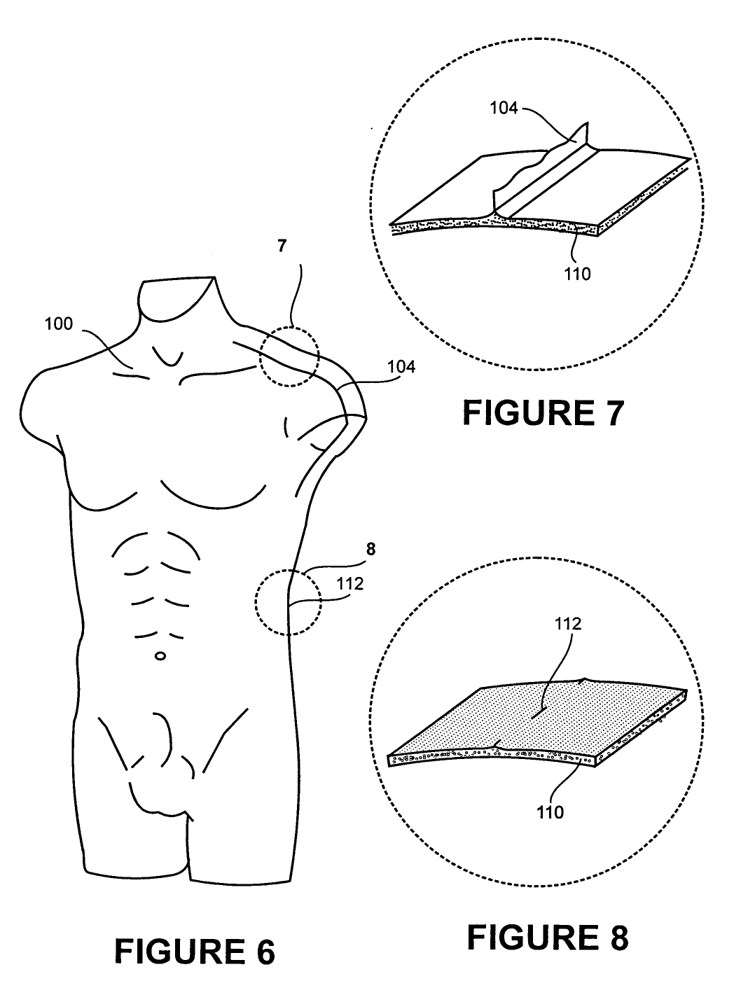

FIG. 6 shows a display form 100 of this invention molded to produce a seam (flash) 104 on the shoulder, which has been removed at the hip to show buffed surface 112. FIG. 7 is an expanded view of a cross-section of form shell 110 showing the flash 104 of FIG. 6. FIG. 8 is an expanded view of a cross-section of form shell 110 showing the buffed flash 112 which has the same color and texture as the rest of the surface of form 100.

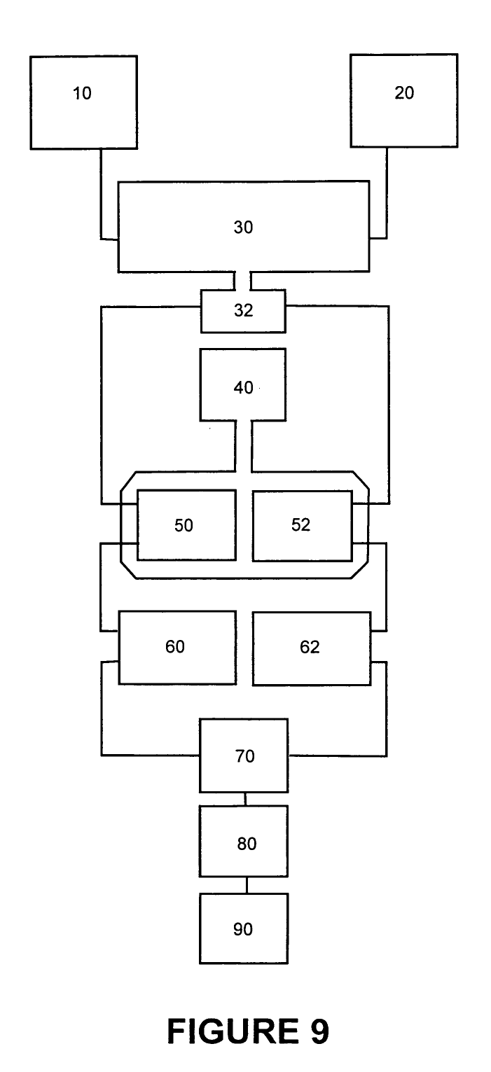

FIG. 9 is a flow chart of the cold rotational molding process. Liquid polyol or polyester (resin) in first container 10 (also referred to as a “tote”) and liquid isocyanate in second container 20 are added simultaneously into a high pressure impingement mixing machine 30, then injected through mix head 32 into molds 50 and 52 which are affixed to a rotation machine 40 which slowly rocks/rotates them while the material gels, over a period of about 2 to about 3.5 minutes, and cures enough to be demolded. The total time the material is resident within the molds should be no more than about nine to about fifteen minutes. The molded articles 60 and 62 are then demolded, and buffed to form deflashed article 70. A quality control step 80 is then typically performed, usually followed by a packaging step 90.

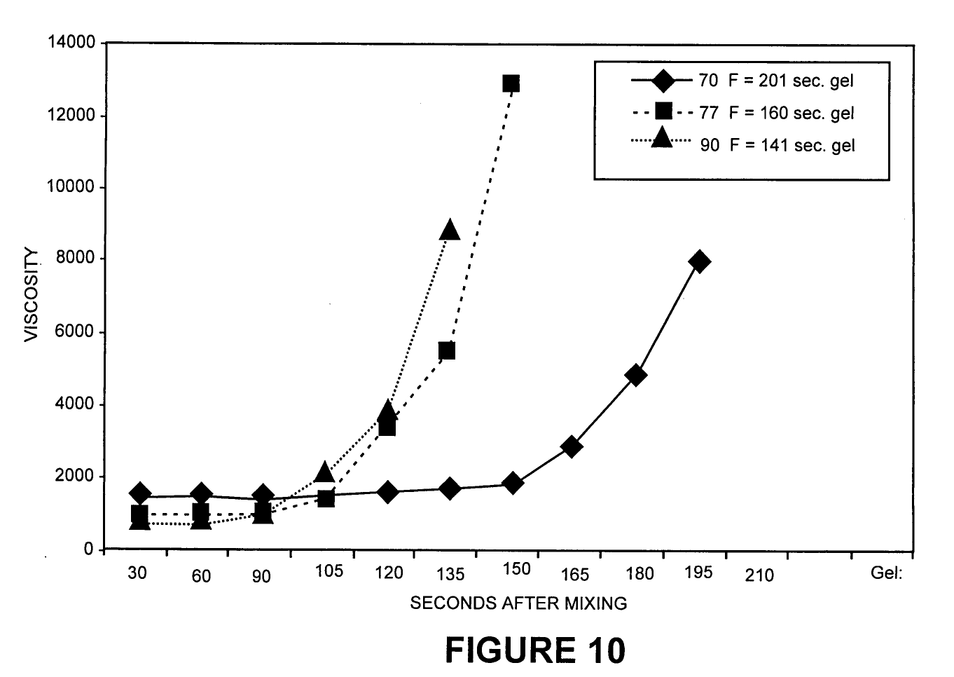

FIG. 10 graphs viscosity profiles of uncolored material having suitable properties during molding. The uncolored material is the standard E-Flex™ material of Fusion Specialties, Inc., Broomfield, Colo., made using BASF resin Product No. 70512R and BASF isocyanate Product No. WUC 3238T ISO. This material has a desirable gel profile. Diamonds indicate the gel profile of the material at 70° F.; squares indicate the gel profile of the material at 77° F.; and triangles indicate the gel profile of the material at 90° F.

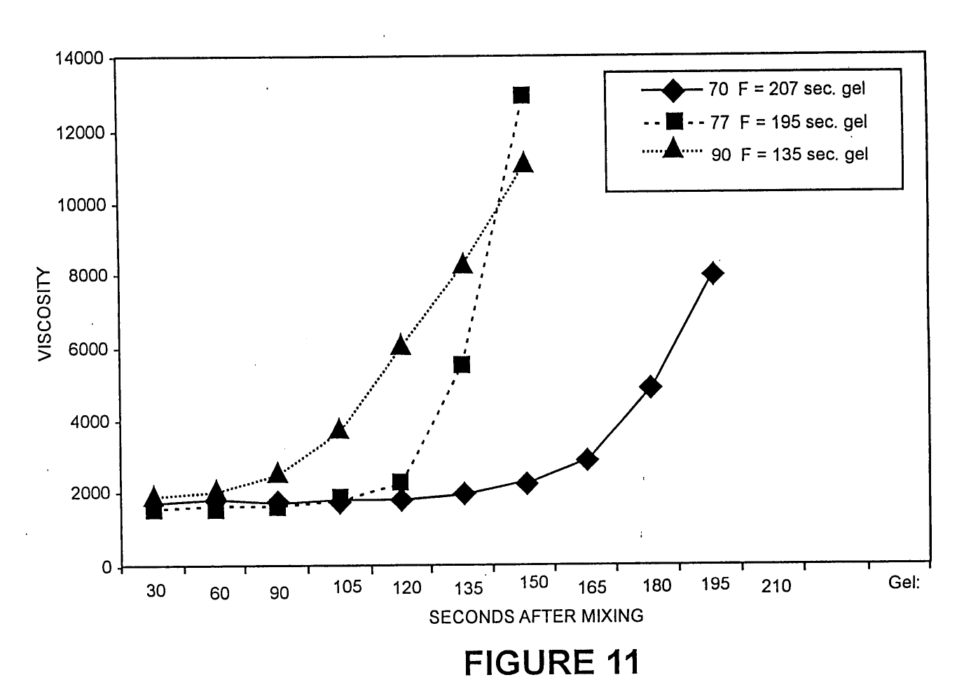

FIG. 11 graphs viscosity profiles of colored material of this invention This material is made using BASF resin Product No. 709905R and BASF isocyanate Product No. I 3647T ISO. Diamonds indicate the gel profile of the material at 70° F.; squares indicate the gel profile of the material at 77° F.; and triangles indicate the gel profile of the material at 90° F. These gel profiles are similar to the desirable gel profiles of the E-Flex™ material shown in FIG. 10.

### EXAMPLES

Mannequins made from three different materials were analyzed, as shown in Table 1:

TABLE 1

| Sample | Resin PN | ISO PN |
|---|---|---|
| 1. Initial Formulation | 2667 | 2629 |
| 2. Baseline (uncolored) | 4176 | 4175 |
| 3. This invention (hand mix) | 70905 | 2629 |
| 4. This invention (production mix) | 70905 | 2629 |

The baseline formula (sample 2) is an uncolored polyurethane material (E-Flex™ of Fusion Specialties, Inc., Broomfield, Colo.). The initial formulation (sample 1) represents an early attempt to color the baseline material, which resulted in loss of many desired properties. The formulations of this invention were either hand mixed (sample 3) or machine-mixed (sample 4). The same components were used, but hand mixing results in slightly more air being present in the formula.

All of the samples were tested to the following standards:
1. ASTM D 648-98, Deflection Temp. Under Load (DTUL)
2. ASTM D 256-97, Izod Impact (Method A)
3. ASTM D 790-99, Flexural Properties at 73^{□}F Temperature
4. ASTM D 790-99, Flexural Properties at 110^{□}F
5. ASTM D 635-98, Linear Burn Rate
6. ASTM E 1164-94, Method for Obtaining Color Measurements
7. 21 Day Cyclic Heat Aging (32^{□F -}120^{□}F, 12 hr cycle)
8. 21 Day Heat Aging (120^{□}F)
9. Dimensional Characterization after exposure
10. ASTM D 2444-99, Tup Impact

### Example 1

### Deflection, Impact, Flexural Properties

ASTM D 648-98, Deflection Temperature Under Load (DTUL)

This test method determines the temperature at which deformation of the material occurs under a controlled set of conditions. A higher temperature indicates that the material remains rigid even at elevated temperatures. A lower temperature indicates that the material is more rubbery and easily deformed.

ASTM D 256-97, Izod Impact (Method A)

This test method determines the energy necessary to break a sample in a controlled medium velocity impact. In Method A, a small notch is placed in the specimen. Notches increase the local stress level, typically producing brittle failure in some polymers. Notches act as stress concentrators, creating weaknesses, and are common (though undesired) features in molded parts. This test is similar to what happens when a part is dropped on a hard floor. High values correspond to tough materials that can better tolerate molded inserts and designs that include sharp square corners and notches.

ASTM D 790-99, Flexural Properties

This is a low velocity test that measures the resistance of a material to bending. The results have direct implications toward the load bearing characteristics of the material. The flexural stress at 5% is the amount of force necessary to bend the sample 5% of its thickness. The flexural modulus of the material is also calculated at this deflection. This deflection is intended to be a relatively small amount of movement so that when the force is removed, the part returns to its original shape. This test is useful for ranking the resistance of materials to loads while they still retain their shape.

The results are summarized in Table 2.

TABLE 2

| | | | Flex at Room Temp. | | Flex at 110° F. | |
|---|---|---|---|---|---|---|
| | | | 5% | Flexural | 5% | Flexural |
| | DTUL | Izod | Stress | modulus | Stress | modulus |
| Sample | (° F.) | (ft lbs./in) | psi | psi | psi | psi |
| 1 | 110 | 0.67 | 5,020 | 170,200 | 670 | 39,000 |
| 2 | 115 | 2.46 | 1,932 | 75,700 | 1,240 | 39,200 |
| 3 | 118 | 2.75 | 2,014 | 80,800 | 1,030 | 39,000 |

### Example 2

### Burn Rate

ASTM D 635-98, Linear Burn Rate

This test measures the response of a plastic material to burning in the horizontal position. This method was originally developed for plastic devices and appliances. This test is used to determine preliminary acceptability of a material in its final geometry. A low number indicates a less flammable material and a high number indicates that the material burns easily. Results are shown in Table 3.

TABLE 3

| | Linear Burn Rate |
|---|---|
| Sample | mm/min. |
| 1 | 87 |
| 2 | 39 |
| 3 | 19 |

### Example 3

### Thermal Aging and Deformation

Two types of thermal aging tests have been conducted. Test A was a cyclic aging test. In this procedure the mannequins were subject to 32^{□}F for six hours and then subject to 120^{□}F for six hours. This cycle was repeated every 12 hours for 21 days (42 cycles). In Test B the samples were subject to a constant temperature environment of 120^{□}F for 21 days. In both tests the samples were upright (supported by a stand) and measurements were taken before and after exposure.

All three formulas tested experienced very little deformation under the constant temperature test.

In the cyclic test, both the prior art formulations showed stress relaxation type deformation from cyclic exposures.

The formulation of this invention showed negligible deformation in either test. Results are shown in Tables 4-6.

TABLE 4

| | | | Test B | |
|---|---|---|---|---|
| | Test A | | #1 | #1 |
| | #1 | #1 | Pre- | Post- |
| | Pre- | Post- | exposure | exposure |
| | exposure | exposure | 21 days at | 21 days at |
| Parameter | Cyclic | Cyclic | 120^{□}F. | 120^{□} F. |
| Stomach | 7.250 | 7.217 | 7.821 | 7.250 |
| diameter | | | | |
| (inches) | | | | |
| Left thigh | 5.575 | 5.596 | 5.577 | 5.575 |
| diameter | | | | |
| (inches) | | | | |
| Right thigh | 5.425 | 5.375 | 5.451 | 5.708 |
| diameter | | | | |
| (inches) | | | | |
| Stomach | 5.712 | 5.824 | 5.918 | 6.173 |
| front-back | | | | |
| Left side | | | | |
| (inches) | | | | |
| Stomach | 5.542 | 5.406 | 6.011 | 6.469 |
| front-back | | | | |
| Right side | | | | |
| (inches) | | | | |
| Right bicep | 2.980 | 2.975 | 2.972 | 2.950 |
| diameter | | | | |
| (inches) | | | | |
| Right forearm | 2.450 | 2.439 | 2.311 | 2.300 |
| diameter | | | | |
| (inches) | | | | |
| Left bicep | 2.775 | 2.781 | 2.827 | 2.825 |
| diameter | | | | |
| (inches) | | | | |
| Left forearm | 2.150 | 2.125 | 2.160 | 2.148 |
| diameter | | | | |
| (inches) | | | | |

TABLE 5

| | | | Test B | |
|---|---|---|---|---|
| | Test A | | #2 | #2 |
| | #2 | #2 | Pre- | Post- |
| | Pre- | Post- | exposure | exposure |
| | exposure | exposure | 21 days at | 21 days at |
| Parameter | Cyclic | Cyclic | 120^{□}F. | 120^{□} F. |
| Stomach | 7.325 | 7.332 | 7.335 | 7.325 |
| diameter | | | | |
| (inches) | | | | |
| Left thigh | 5.665 | 5.648 | 5.665 | 5.667 |
| diameter | | | | |
| (inches) | | | | |
| Right thigh | 5.696 | 5.688 | 5.670 | 5.720 |
| diameter | | | | |
| (inches) | | | | |
| Stomach | 5.680 | 6.204 | 5.412 | 5.364 |
| front/back | | | | |
| Left side | | | | |
| (inches) | | | | |
| Stomach | 5.629 | 6.155 | 5.357 | 5.208 |
| front/back | | | | |
| Right side | | | | |
| (inches) | | | | |
| Right bicep | 3.250 | 2.975 | 3.011 | 2.985 |
| diameter | | | | |
| (inches) | | | | |
| Right forearm | 2.250 | 2.765 | 2.608 | 2.581 |
| diameter | | | | |
| (inches) | | | | |
| Left bicep | 2.825 | 2.404 | 2.915 | 2.923 |
| diameter | | | | |
| (inches) | | | | |
| Left forearm | 2.150 | 2.150 | 2.270 | 2.258 |
| diameter | | | | |
| (inches) | | | | |

TABLE 6

| | | | Test B | |
|---|---|---|---|---|
| | Test A | | #4 | #4 |
| | #4 | #4 | Pre- | Post- |
| | Pre- | Post- | exposure | exposure |
| | exposure | exposure | 21 days at | 21 days at |
| Parameter | Cyclic | Cyclic | 120^{□}F. | 120^{□}F. |
| Stomach | 7.325 | 7.330 | 7.350 | 7.350 |
| diameter | | | | |
| (inches) | | | | |
| Left thigh | 5.915 | 5.915 | 5.920 | 5.915 |
| diameter | | | | |
| (inches) | | | | |
| Right thigh | 5.875 | 5.880 | 5.900 | 5.890 |
| diameter | | | | |
| (inches) | | | | |
| Stomach | 5.625 | 5.620 | 5.625 | 5.630 |
| front/back | | | | |
| Left side | | | | |
| (inches) | | | | |
| Stomach | 5.631 | 5.630 | 5.640 | 5.640 |
| front/back | | | | |
| Right side | | | | |
| (inches) | | | | |
| Right bicep | 2.975 | 2.975 | 3.000 | 2.995 |
| diameter | | | | |
| (inches) | | | | |
| Right forearm | 2.510 | 2.500 | 2.510 | 2.510 |
| diameter | | | | |
| (inches) | | | | |
| Left bicep | 2.820 | 2.825 | 2.835 | 2.840 |
| diameter | | | | |
| (inches) | | | | |
| Left forearm | 2.160 | 2.165 | 2.205 | 2.200 |
| diameter | | | | |
| (inches) | | | | |

### Example 4

### Tup Impact

ASTM D 2444-99, Tup Impact

This method covers the determination of the impact resistance of a plastic by means of a tup B falling weight. In this test the weight is raised to different heights and dropped onto the part. The height is increased and the type of failure (if any) is recorded. In the case of the mannequins there was a clear height above which the samples cracked or shattered. The maximum height the parts could sustain without breaking is reported. All materials were tested using the upper arm of the mannequin.

The formulation of this invention is clearly superior to the prior art. Results are shown in Table 7.

TABLE 7

| Sample | 20-lb Tup | 12-lb Tup | Total foot pounds |
|---|---|---|---|
| 1 | — | 1.5 feet | 18 |
| 2 | 5 feet | — | 100 |
| 3 | — | 5 feet | 60 |

These results show that addition of pigment to known polyurethane compositions adversely affects properties important to molded display articles, particularly mannequins, and that the compositions of this invention provide adequate to superior properties in a colored polyurethane mix for molding.

### Example 5

### Gelling Period

150 grams of a machine mixture comprising E-Flex™ material of Fusion Specialties, Inc., Broomfield, Colo., BASF Elastocast 70512R resin and WUC 3238T ISO isocyanate, as well as BASF catalyst CSDRHO38 was prepared, and viscosity was tested at 70 F, 77° F. and 90° F. Results are shown in Table 8 and FIG. 10.

TABLE 8
Viscosity (cps) of E-Flex ™

| Time | Temperature | Temperature | Temperature |
|---|---|---|---|
| Sec. | 70° F. | 77° F. | 90° F. |
| 0 | | 970 | |
| 30 | 1500 | 1000 | 800 |
| 60 | 1500 | 1000 | 800 |
| 90 | 1400 | 1000 | 1000 |
| 105 | 1500 | 1400 | 2100 |
| 120 | 1600 | 3400 | 3800 |
| 135 | 1700 | 5500 | 8800 |
| 150 | 1800 | 13000 | 8800 |
| 165 | 2800 | 13000 | |
| 180 | 4800 | | |
| 195 | 7900 | | |
| 210 | 7900 | | |
| GEL: | 201 sec. | 160 sec. | 141 sec. |

150 grams of a machine mixture of this invention using bright white REPITAN 18361 of Repi S.p.A., BASF Elastocast 70905R resin and Elastofoam I3647T ISO, using BASF catalyst 40850A was prepared, and viscosity was tested at 70° F., 77° F. and 95° F. Results are shown in Table 9 and FIG. 11.

TABLE 9
Viscosity (cps) of Material of this Invention

| Time | Temperature | Temperature | Temperature |
|---|---|---|---|
| Sec. | 70° F. | 77° F. | 95° F. |
| 0 | | 1120 | |
| 30 | 1650 | 1530 | 1860 |
| 60 | 1750 | 1650 | 2000 |
| 90 | 1700 | 1600 | 2500 |
| 105 | 1750 | 1800 | 3700 |
| 120 | 1800 | 2200 | 6000 |
| 135 | 1900 | 5500 | 8200 |
| 150 | 2200 | 13000 | 11000 |
| 165 | 2800 | 13000 | 11000 |
| 180 | 4800 | | |
| 195 | 7900 | | |
| 210 | 7900 | | |
| GEL: | 207 sec. | 195 sec. | 135 sec. |

These results show that the material of this invention provides a gelling profile a good as or better than the baseline material which is unpigmented.

While the invention has been explained in relation to its preferred embodiments, it is to be understood that the various modifications thereof will become apparent to those skilled in the art upon reading this specification. Therefore, it is to be understood that the invention disclosed herein is intended to cover such modification as fall within the scope of the appended claims.

1. A method for making a molded display form of an elastomeric composition, said method comprising:
a. providing a pigment or dye effective to produce a desired color in said form;
b. providing polyol or polyester resin components;
c. providing isocyanate components;
d. providing a curing catalyst;
e. mixing said pigment or dye, resin and isocyanate components, and said curing catalyst;
f. putting said mixture into a mold;
g. rocking or rotating the mold in multiple directions;
h. allowing said mixture to remain within said mold for a gelling period of about 9 to about 15 minutes to produce a molded form;
i. removing said molded form from said mold.

2. The method of claim 1 wherein the gel profile is substantially flat for the first half of the gelling period, begins to rise thereafter, and rises steeply during the last quarter of the gelling period.

3. The method of claim 1 wherein said mold is made of a non-metallic material.

4. The method of claim 1 wherein said mold is made of fiber-reinforced epoxy resin.

5. The method of claim 1 wherein said mold is preheated to a temperature of at least about 120° F. prior to putting said mixture therein.

6. The method of claim 1 wherein said pigment or dye is mixed into said polyol or polyester component prior to mixing in said isocyanate components;

7. The method of claim 6 wherein said pigment or dye and polyol or polyester mixture is mixed with said isocyanate components via impingement mixing.

8. The method of claim 1 wherein an ultraviolet stabilizer is also added to said mixture.

9. The method of claim 1 wherein a drying agent is also added to said mixture.

10. The method of claim 1 wherein an antifoaming agent is also added to said mixture.

11. The method of claim 1 wherein a catalyst is added to said mixture in an amount no more than about 0.2% of the resin component.

12. The method of claim 1 wherein said mixture has a viscosity between about 500 and about 4000 cp at the time of being put into the mold.

13. The method of claim 12 wherein a seam line formed or other unwanted protuberance on said molded form is removed by abrasion.

14. The method of claim 13 wherein the surface of said form has been buffed to a uniform matte finish.

15. A method for making a molded article, selected from the group consisting of urns, frames, furniture, fixtures, display props and garden furniture, of an elastomeric composition, said method comprising:
a. providing a pigment or dye effective to produce a desired color in said article;
b. providing polyol or polyester resin components;
c. providing isocyanate components;
d. providing a curing catalyst;
e. mixing said pigment or dye, resin and isocyanate components, and said curing catalyst;
f. putting said mixture into a mold;
g. rocking or rotating the mold in multiple directions;
h. allowing said mixture to remain within said mold for a gelling period of about 9 to about 15 minutes to produce a molded article;
h. removing said molded article from said mold.
